(19) United States
(12) Patent Application Publication
(10) Pub. No.: US 2011/0154214 A1
(43) Pub. Date: Jun. 23, 2011

(54) Offloading Content Retrieval And Decoding In Pluggable Content-Handling Systems

(75) Inventor: Rajneesh Mahajan, Bellevue, WA (US)

(73) Assignee: Microsoft Corporation, Redmond, WA (US)

(21) Appl. No.: 12/642,581

(22) Filed: Dec. 18, 2009

(51) Int. Cl. G06F 15/16; G06F 3/048

(52) U.S. Cl. 715/738

(57) ABSTRACT

Systems, methods and computer-readable storage media are disclosed for offloading content retrieval and decoding in pluggable content-handling systems. This may be accomplished by the server sending the client a frame that comprises video as two parts—the un-decoded video data, and the rest of the frame. The client then uses the application content handler to decode video image corresponding to the video data and combine it with the rest of the frame to recreate the frame. The server may execute a proxy for content handler to perform the communications to retrieve the media. The client may execute content handler using a stub application that corresponds to content handler, such that operations content handler performs are performed as if it were interacting with the application.

### BACKGROUND OF THE INVENTION

Although computers were once isolated and had minimal or little interaction with other computers, computers now interact with a wide variety of other computers through Local Area Networks (LANs), Wide Area Networks (WANs), dial-up connections, and the like. With the wide-spread growth of the Internet, connectivity between computers has become more important and has opened up many new applications and technologies. The growth of large-scale networks, and the wide-spread availability of low-cost personal computers, has fundamentally changed the way that many people work, interact, communicate, and play.

One increasing popular form of networking may generally be referred to as remote presentation systems, which can use protocols such as Remote Desktop Protocol (RDP), Independent Computing Architecture (ICA), and others to share a desktop and other applications with a remote client. Such computing systems typically transmit the keyboard presses and mouse clicks or selections from a client computing device to a server computing device, relaying the screen updates back in the other direction over a communications network (e.g., the INTERNET™). As such, the user has the experience as if his session is being executed entirely on his client computer when in reality the client is only sent screenshots, or frames, of the applications as they appear on the server side.

Commonly in a remote presentation system, graphics data is encoded on the server and then transferred to the client for presentation on the client display. Where media, such as video or an animation, is to be remotely displayed, it is first decoded from a native format (e.g. H.264, or WMV) to another format, such as a bitmap. The bitmap is then encoded for transmission to the client. This decoding and encoding process is computationally expensive for the server, particularly when it is concurrently conducting many such remote presentation sessions, and requires a large amount of bandwidth to transfer the decoded and decoded media to the client (as measured against the bandwidth required to transfer the natively encoded media). This may result in the server needing to drop frames, either because it cannot decode them all, or because it cannot send them all to the client, and therefore a degraded client experience.

### SUMMARY OF THE INVENTION

It would therefore be an improvement over the prior art to reduce the demands on the server in a remote presentation session where media is to be displayed through the use of a content handler for an application.

In an embodiment, a content handler is a plug-in. For instance, the application may be MICROSOFT INTERNET EXPLORER™, the media may be a video in WINDOWS MEDIA VIDEO™ video format, and the content handler may be a MICROSOFT SILVERLIGHT™ ACTIVEX™ content handler plug-in that handles decoding and presenting the media when viewed in a web page in INTERNET EXPLORE™. In another embodiment, the video is in FLASH™ format and the content handler is a FLASH™ ACTIVEX™ content handler.

This improvement be accomplished by the server sending the client a frame that comprises media as two parts—the encoded media, and the rest of the frame. Using the embodiment above, the encoded media would comprise the video, and the rest of the frame would comprise the INTERNET EXPLORER™ application window not occupied by the video (e.g. the navigation buttons and border, and the rest of the web page upon which the video is presented). The client then uses the content handler in conjunction with a stub container to decode an image corresponding to the encoded media data and combine the image with the rest of the frame to recreate the frame as it appeared on the server (less any lossy encoding during the remote presentation session, or the like).

Stub container may comprise a lightweight application that is configured to manage the content handler in the same manner that the content handler's corresponding application would manage it. Using the above example again, the stub container would provide to SILVERLIGHT™ ACTIVEX™ content handler the same communications that SILVERLIGHT™ ACTIVEX™ content handler would receive were it executing within INTERNET EXPLORER™, even though the stub container may not implement most of the functionality of INTERNET EXPLORER™, such as the ability to decode web pages (hence the designation of a stub container as a “lightweight” application).

In an embodiment where the media is stored on a media server computing device separate from the server, the media may be sent directly to the client, bypassing the server.

In an embodiment, the server retrieves the media stored on the media server, and passes it to the client for decoding. It may do this through the use of a proxy content handler that is able to communicate with the server as the content handler would, and then transmit the media data that it receives to the client.

This disclosure encompasses systems, methods and computer-readable storage media for implementing these teachings.

The primary embodiments described herein discuss computer-executable instructions executed by one or more processors of a computing device. However, it may be appreciated that these techniques may be implemented entirely in terms of hardware, such as through appropriately programming field-programmable gate arrays (FPGAs), or some combination thereof. It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer-readable media for offloading content retrieval and decoding in pluggable content-handling systems are further described with reference to the accompanying drawings in which:

FIG. 1 illustrates an example general purpose computing environment in which in which the techniques described herein may be embodied.

FIG. 2 illustrates an example system in which a client and server communicate in a remote presentation session, and in which the server acts as a proxy to retrieve media from a media server for the client.

FIG. 3 illustrates an example system in which a client and server communicate in a remote presentation session as described in FIG. 2, and in which the client retrieves media from a media server that is to be displayed in the remote presentation session.

FIG. 4 illustrates example operational procedures for a client engaged in a remote presentation session in which there is offloading of content retrieval and decoding in a pluggable content-handling system.

FIG. 5 illustrates example operational procedures for a server engaged in a remote presentation session in which there is offloading of content retrieval and decoding in a pluggable content-handling system.

FIG. 6A depicts a first browser window in which media is displayed, and a second browser window, as referenced in FIG. 2.

FIG. 6B depicts the first and second browser windows of FIG. 6A in which the second browser window obscures a portion of the media of the first browser window.

### DETAILED DESCRIPTION OF ILLUSTRATIVE EMBODIMENTS

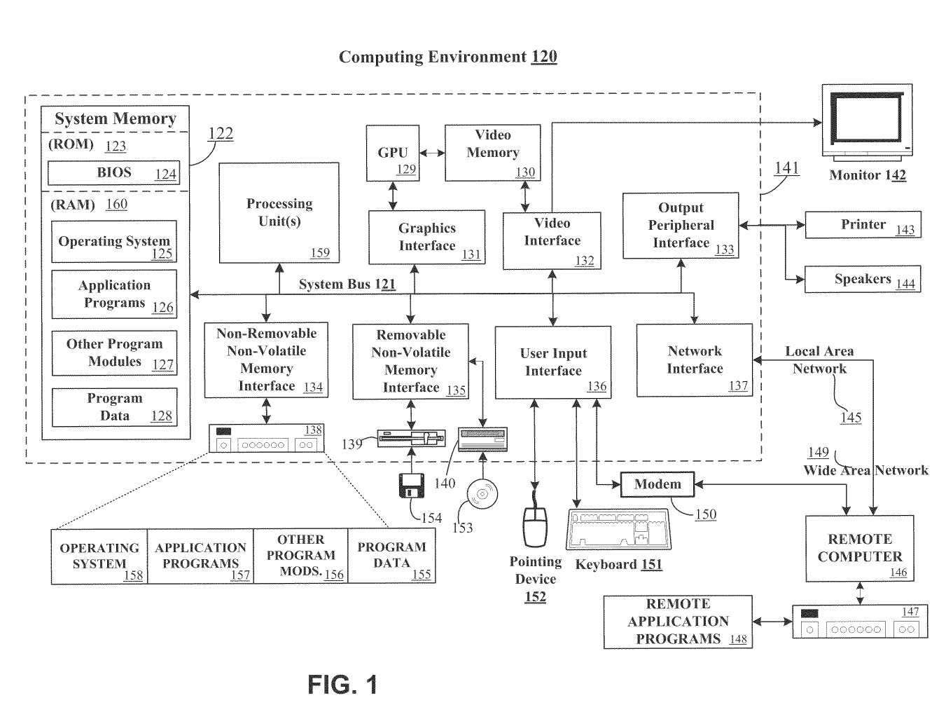

FIG. 1 is a block diagram of a general purpose computing device in which the techniques described herein may be employed. The computing system environment 120 is only one example of a suitable computing environment and is not intended to suggest any limitation as to the scope of use or functionality of the presently disclosed subject matter. Neither should the computing environment 120 be interpreted as having any dependency or requirement relating to any one or combination of components illustrated in the example operating environment 120. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 141 typically includes a variety of computer-readable media. Computer-readable media can be any available media that can be accessed by computer 141 and includes both volatile and nonvolatile media, removable and non-removable media. The system memory 122 includes computer-readable storage media in the form of volatile and/or nonvolatile memory such as read only memory (ROM) 123 and random access memory (RAM) 160. A basic input/output system 124 (BIOS), containing the basic routines that help to transfer information between elements within computer 141, such as during start-up, is typically stored in ROM 123. RAM 160 typically contains data and/or program modules that are immediately accessible to and/or presently being operated on by processing unit 159. By way of example, and not limitation, FIG. 1 illustrates operating system 125, application programs 126, other program modules 127, and program data 128.

The computer 141 may also include other removable/non-removable, volatile/nonvolatile computer storage media. By way of example only, FIG. 1 illustrates a hard disk drive 138 that reads from or writes to non-removable, nonvolatile magnetic media, a magnetic disk drive 139 that reads from or writes to a removable, nonvolatile magnetic disk 154, and an optical disk drive 140 that reads from or writes to a removable, nonvolatile optical disk 153 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 138 is typically connected to the system bus 121 through an non-removable memory interface such as interface 134, and magnetic disk drive 139 and optical disk drive 140 are typically connected to the system bus 121 by a removable memory interface, such as interface 135.

The drives and their associated computer storage media discussed above and illustrated in FIG. 1, provide storage of computer-readable instructions, data structures, program modules and other data for the computer 141. In FIG. 1, for example, hard disk drive 138 is illustrated as storing operating system 158, application programs 157, other program modules 156, and program data 155. Note that these components can either be the same as or different from operating system 125, application programs 126, other program modules 127, and program data 128. Operating system 158, application programs 157, other program modules 156, and program data 155 are given different numbers here to illustrate that, at a minimum, they are different copies. A user may enter commands and information into the computer 141 through input devices such as a keyboard 151 and pointing device 152, commonly referred to as a mouse, trackball or touch pad. Other input devices (not shown) may include a microphone, joystick, game pad, satellite dish, scanner, or the like. These and other input devices are often connected to the processing unit 159 through a user input interface 136 that is coupled to the system bus, but may be connected by other interface and bus structures, such as a parallel port, game port or a universal serial bus (USB). A monitor 142 or other type of display device is also connected to the system bus 121 via an interface, such as a video interface 132. In addition to the monitor, computers may also include other peripheral output devices such as speakers 144 and printer 143, which may be connected through a output peripheral interface 133.

The computer 141 may operate in a networked environment using logical connections to one or more remote computers, such as a remote computer 146. The remote computer 146 may be a personal computer, a server, a router, a network PC, a peer device or other common network node, and typically includes many or all of the elements described above relative to the computer 141, although only a memory storage device 147 has been illustrated in FIG. 1. The logical connections depicted in FIG. 1 include a local area network (LAN) 145 and a wide area network (WAN) 149, but may also include other networks. Such networking environments are commonplace in offices, enterprise-wide computer networks, intranets and the Internet.

When used in a LAN networking environment, the computer 141 is connected to the LAN 145 through a network interface or adapter 137. When used in a WAN networking environment, the computer 141 typically includes a modem 150 or other means for establishing communications over the WAN 149, such as the Internet. The modem 150, which may be internal or external, may be connected to the system bus 121 via the user input interface 136, or other appropriate mechanism. In a networked environment, program modules depicted relative to the computer 141, or portions thereof, may be stored in the remote memory storage device. By way of example, and not limitation, FIG. 1 illustrates remote application programs 148 as residing on memory device 147. It will be appreciated that the network connections shown are example and other means of establishing a communications link between the computers may be used.

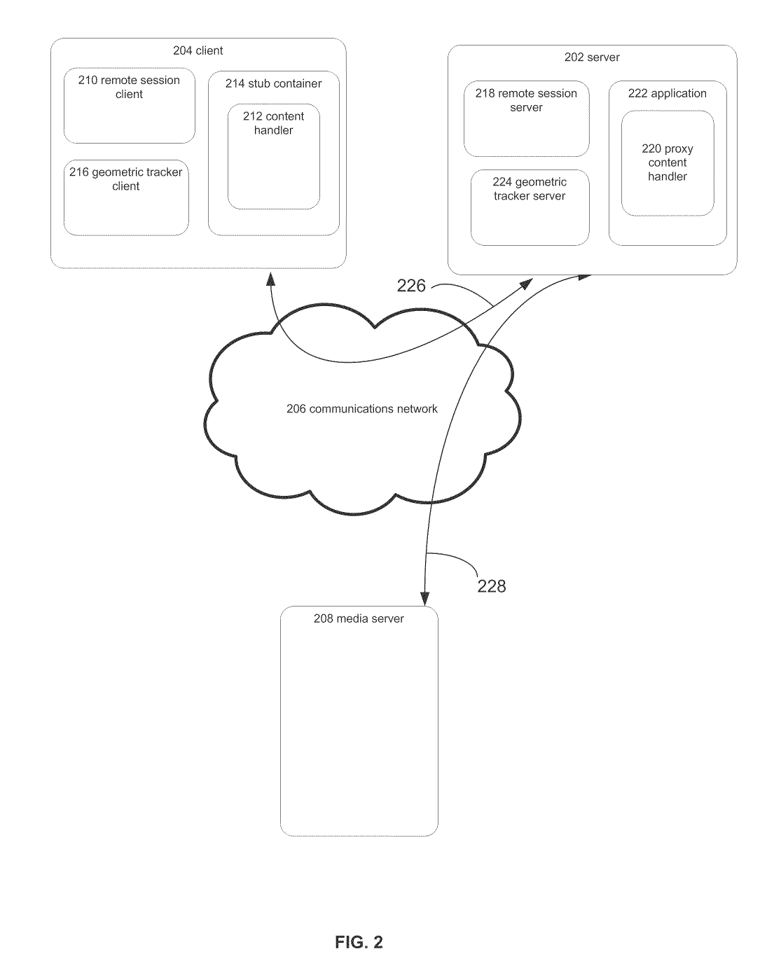

FIG. 2 illustrates an example system in which a client 204 and server 202 communicate in a remote presentation session, and in which the server 202 acts as a proxy to retrieve media from a media server 208 for the client 204.

The components of this, and other systems discussed herein are organized logically, and it may be appreciated that they can be combined in various permutations in an embodiment, and that not every component is present in every embodiment.

In an embodiment, server 202 and client 204 communicate in a remote presentation session across communications network 206. Server 202 and client 204 communicate via communications link 226. Server 202 and media server 208 communicate via communications link 228. Where client 204 and media server 208 communicate, it is through server 202 via communication link 226 and communication link 228. In an embodiment, each of server 202, client 204 and media server 208 may be implemented in the computing device of FIG. 1. In the course of the remote presentation session, server 202 sends client 204 a plurality of frames corresponding to the graphical output of one or more applications executing on server 202. In the course of sending these frames, server 202 may need to send a frame that comprises the graphical output of a decoded media along with the image data that server 202 usually sends to client 204 (in this case, server 202 is fetching the natively encoded media from media server 208 and sending it to client 202 for decoding and rendering). For instance, this may comprise a web browser displaying a web page, on which video is to be played.

As in the example discussed in the Summary, the web browser may be INTERNET EXPLORER™, and the media is a video in WMV format is to be played in it through the use of a SILVERLIGHT™ ACTIVEX™ content handler 212. In another embodiment, the media is a video in FLASH™ format to be played through the use of a FLASH™ content handler 212.

In the present embodiment, client 204 comprises a remote presentation session client 210, content handler 212, stub container 214 for content handler 212, and geometric tracker client 216.

A stub container 214 as used herein refers to circuitry, computer-executable instructions, or the like, that mimics an application 222 associated with content handler 212. A content handler 212 may not normally execute by itself, but executes in relation to commands sent to and received from an associated application 222. Where client 204 is engaged in a remote presentation session with server 202, that associated application 222 will execute on server 202 and the graphical output of that application 222 will be sent to client 204. It is not necessary for client 204 to store or execute a copy of the application 222 to use it through a remote presentation session. Even if client 204 does have the application 222, it does not need to execute a full copy of the application 222 to make use of content handler 212, and have the associated cost of computing resources. Client 204 may execute only stub container 214, which may then interface with content handler 212 as is necessary within the remote presentation session. Executing a stub container 214 to interface with a content handler 212 typically requires fewer computing resources than executing a corresponding full application 222 to do the same (there are several other reasons why an application such as application 222 may be executed remotely in a remote presentation session, rather than locally. For instance, having a single copy of application 222 on server 202 may be easier to update and maintain than by having a separate copy of the application on multiple clients 204).

In the present embodiment, server 202 comprises remote presentation session server 218, proxy content handler 220, and application 222, and geometric tracker server 224. Application 222 corresponds to stub container 214 on client 204. For instance, where application 222 is an INTERNET EXPLORER™ application, stub container 214 is a stub container 214 for INTERNET EXPLORER™,

Server 202 and client 204 may communicate to determine whether client 204 is to handle any of the retrieval or presentation of media, and if so, how much. This communication may include whether client 204 is capable of local retrieval and decoding of media. Such communication may involve the availability of content handler 212 on client 204, the network conditions, client 204's computational resources, and administrator or user preferences. This communication may occur, for instance, when the remote presentation session is initialized, or when a particular content handler 212 is first needed within the remote presentation session. This communication may also comprise capabilities of server 202, such as whether it has an appropriate proxy content handler.

When this communication occurs may be optimized based on the particulars of the system. In an embodiment, the communication may be selected to occur when the remote presentation session is initialized, because this will likely reduce lag later when the media is selected for presentation. A user may find it less bothersome to have a longer session initialization period than a pause during the middle of a remote presentation session while the communication occurs. In an embodiment, the communication may be selected to occur when a particular content handler 212 is first needed within the remote presentation session. This may be preferable if content handler 212 is unlikely to be used in the session, so the processing resources involved with the communication should only be used if necessary.

For instance, where client 204 lacks the appropriate content handler 212 to decode the media, server 202 may both retrieve and decode the media before sending the image output of it to client 204. This comprises a remote presentation session without content offload.

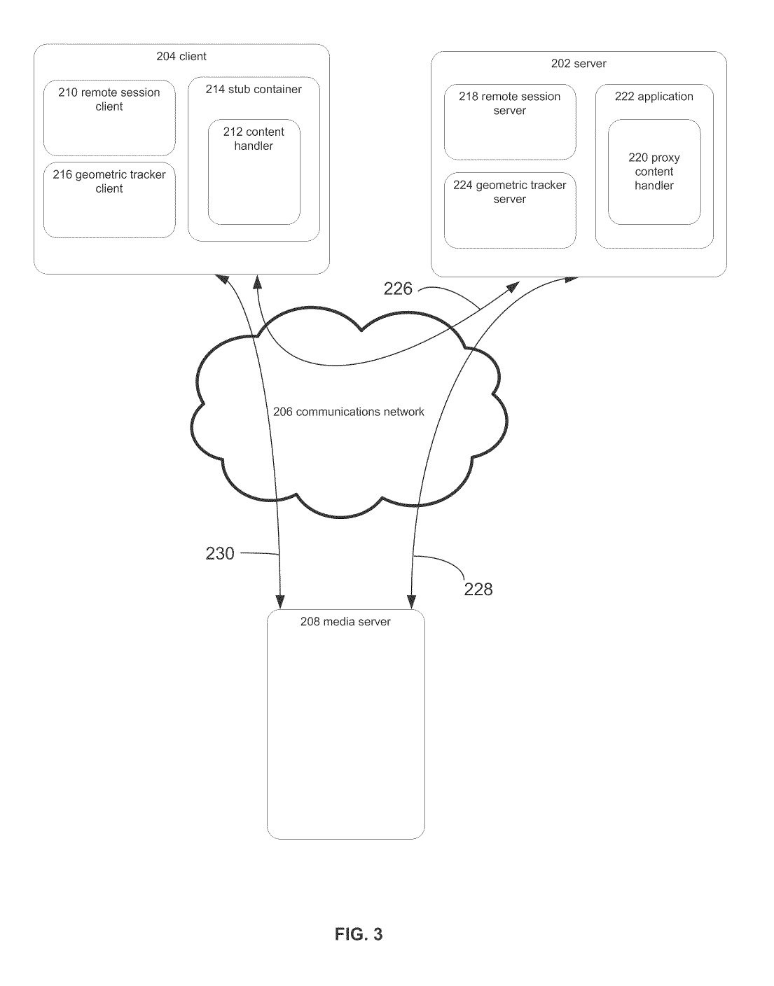

Further, it may be determined that client 204 has the capability to both decode the media and access the media from media server 208. In this instance, client 204 may receive the media from media server 208 without intervention from server 202 and also decode the media. This embodiment is discussed in more detail with respect to FIG. 3.

Further, it may be determined that client 204 has the capability to decode the media, but client 204 does not have the ability to access the media directly from media server 208, upon which the media is stored, and server 202 can access the media from media server 208. This may occur, for instance, when media server 208 and server 202 are connected on an intranet communications network that client 204 does not have access to. This is the embodiment discussed in detail with respect to the embodiment of FIG. 2.

In an embodiment where both server 202 and client 204 can decode the media, they may negotiate as to which one decodes the media, such as based on the available processing resources of each computing device.

Where it is determined through this communication that client 204 will decode the media, proxy content handler 220 sends initialization parameters to stub container 214 on client 204. Such initialization parameters may include things like media server 208's address, the visual location of the content's output on the server 202, and security settings. Such parameters may also include parameters from media server 208, such as the dimensions that the media should be decoded in. Stub container 214 uses the initialization parameters to invoke content handler 212 in a similar way as proxy content handler 220 is initialized on server 202. From this point on, content handler 212 is able to retrieve the media from the media server 208 and decode it locally to client 204. If the content retrieval is requested on the server 202, proxy content handler 220 retrieves the data from media server 208 and tunnels it to stub container 214 which passes it onto content handler 212 for decoding.

Where server 202 will offload presentation of the media to client 204, server 202 operates a proxy for content handler 212, the proxy configured to communicate with media server 208 in the same manner that content handler 212 would communicate with media server 208. For example, proxy content handler 220 is configured to make a registration contract with the server 202, which allows proxy content handler 220 to be loaded in place of content handler 212 in the containing application 222 running on server 202. Proxy content handler 220 may also be configured to make an incoming commands contract of content handler 212, which allows proxy content handler 220 to receive various commands and calls from application 222 (as content handler 220 would have received them were it in proxy content handler 212's place on server 202). Proxy content handler 220 may be further configured to make a notifications or outgoing commands contract, which lets the containing application 222 receive notifications from proxy content handler 220 like it would have received from content handler 212.

During the course of the remote presentation session, client 204 may cause server 202 to encounter an event where a content handler 212 is to be executed in conjunction with an application 222. For instance, client 204 may instruct server 202 to open a web site within a web browser, the web site containing media, such as video, that is to be presented via content handler 212. The application 222 executes on server 202. When it encounters the media, it performs operations consistent with loading content handler 212. However, where server 202 and client 204 have determined that content handler 212 on client 204 will decode the media, application 222 instead ends up loading proxy content handler 220.

Application 222 interacts with media server 208 to retrieve the media. It passes the received media and instructions from media server 208 to proxy content handler 220, and proxy content handler 220 passes them to content handler 212 on client 204. This may be done, for example, by proxy content handler 220 passing them to remote presentation session server 218, which passes them to remote presentation session client 210, which passes them to stub container 214, which passes them to content handler 212.

Content handler 212 may include functionality for how the media is experienced, and the use of this functionality may comprise instructions that are to be sent to media server 208. For instance, the MICROSOFT™ SILVERLIGHT™ content handler 212 has the functionality to provide navigation features, such as selecting a new media to view from a list provided within MICROSOFT™ SILVERLIGHT™, that are executed in the media in a corresponding manner. Where server 202 acts as a proxy for content handler 212, use of these navigation buttons is sent through the server 202. For instance, where a new media is selected from within content handler 212, this selection is received by stub container 214, which sends it to remote presentation session client 210, which sends it to remote presentation session server 218, which sends it to application 222, which sends it to media server 208, where it is executed. Likewise, communications from media server 208 to content handler 212 are passed in a similar way.

During the process of content decoding and/or retrieval, proxy content handler 220 transfers incoming commands from application 222 to stub container 214 which, in turn, sends them to content handler 212. Any notifications or outgoing commands from content handler 212 get passed onto stub container 214 on client 204, which sends it to proxy content handler 220 on the server 202. Proxy content handler 220 duplicates these notifications or outgoing commands and provides them to application 222.

The display elements of proxy content handler 220 are synchronized with stub container 214 (and hence content handler 212) such that the decoded frame on client 204 represents the same image as it would if the entire frame were decoded on server 202 and sent to client 204 for display.

Once application 222 ends the content decoding, proxy content handler 220 is unloaded. Before unloading, the proxy container sends commands to client 204 to unload stub container 214 and content handler 212.

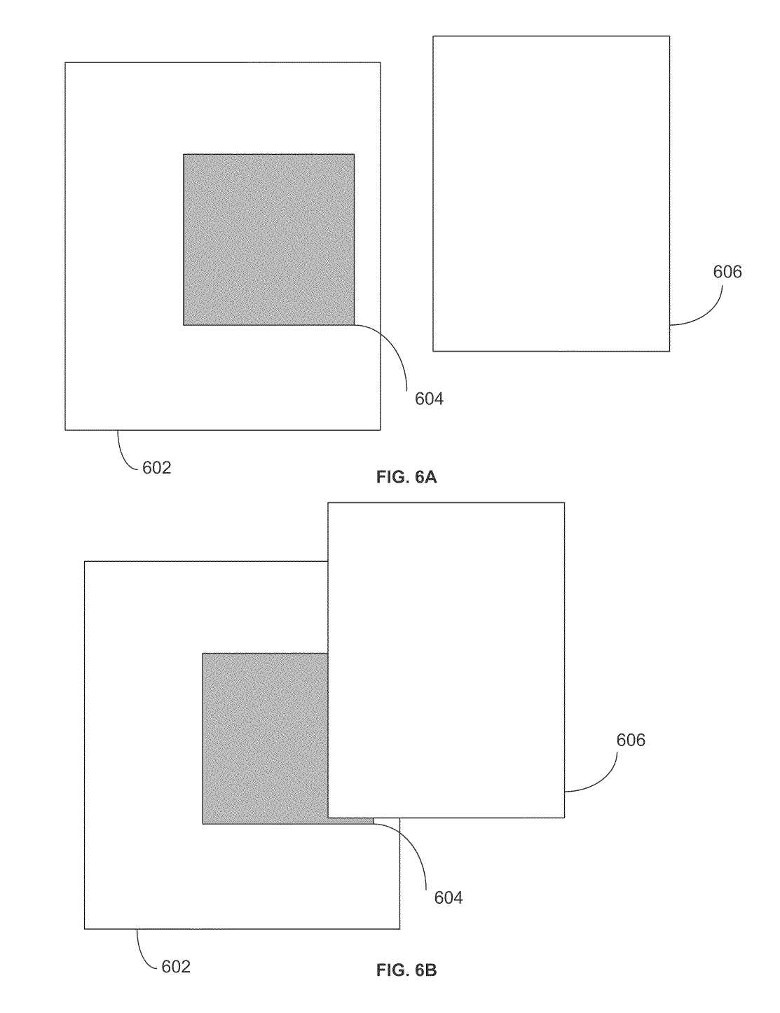

During the remote presentation session, the decoded media may become obscured, and this may be monitored through geometric tracking Geometric tracking may be considered the process by which server 202 and client 204 are in mutual understanding of the shape of the window where media will be displayed on the client 204. For instance, where the session displays two web browser windows, media may be decoded in one window, and then the second window may be moved over part or all of the first page (this is portrayed in FIGS. 6A and 6B). Geometric tracker server 224 operates to monitor the display and arrangement of windows and media on server 202. Where it detects that the media has been obscured, it determines the shape of the viewable area of the media, and transmits an indication of what that viewable area is to geometric tracker client 216.

For instance, the media may comprise an 800×400 pixel rectangle, and the right half of the rectangle may become obscured. Geometric tracker server 224 may determine that this occurred, and send an indication to geometric tracker client 216 that the rightmost 400×400 pixel area of the media is not to be displayed, and to make only a container shape for the media of the leftmost 400×400 pixel area. The container shape for the media may become nonrectangular, or otherwise differ from its shape type, through partial obscuring by windows on the server 202.

FIG. 3 illustrates an example system in which a client 204 and server 202 communicate in a remote presentation session as described in FIG. 2, and in which client 204 retrieves media from a media server 208 that is to be displayed in the remote presentation session.

As discussed with respect to FIG. 2, where client 204 and server 202 conduct a remote presentation session, client 204 may request that server 202 execute an application 222 and an associated content handler 212 and send the graphical output of that execution to client 204 for display. Server 202 and client 204 communicate via communications link 226 as in FIG. 2, and server 202 and media server 208 communicate via communications link 228 as in FIG. 2. However, in contrast to FIG. 2, client 204 and media server 208 are configured to communicate via communications link 230, independent of server 230. In an embodiment where client 204 and media server 208 are configured to communicate via communications link 230 they may also communicate through server 202 via communications link 226 and communications link 228.

In the process of negotiation between client 204 and server 202 described in FIG. 2, it may be determined that client 204 is able to access media from media server 208 without intervention from server 202. This may be determined, for example, by client 204 pinging media server 208 and receiving a response, or by client 204 successfully downloading a portion of media from media server 208.

In this embodiment, server 202 neither retrieves media from media server 208, nor sends media (either decoded and decoded or not) to client 204. This leaves a hole in the frame that server 202 is to send to client 204 in the remote presentation session—the hole occupied by the decoded and rendered media.

In an embodiment, server 202 signals to client 204 that it will not be sending client 204 a portion of the frame corresponding to where the media is to be displayed. In an embodiment, server 202 fills the area of the frame that would be occupied by the media with an image (that will then be obscured on client 204 when the decoded and rendered media is overlaid on top of it). In an embodiment, server 202 fills the area with something highly and/or easily compressible—such as a single color (e.g. white). In making this compressible, server 202 may reduce its own processing resources needed to compress it, as well as the bandwidth required to send it to client 204.

Where client 204 receives both the media and the frame, it combines the two to create the image as requested through the remote presentation session. In an embodiment, server 202 indicates to client 204 a location within the frame of where the media is to be displayed, and client 204 displays the image there. For instance, where the remote presentation session comprises an application 222 window on client 204 the server 202 may indicate the position within the window (e.g. a number of pixels to the right and/or down from the upper-left corner of the window). In this manner, when the application 222 window is moved, the location of where to display the media does not change.

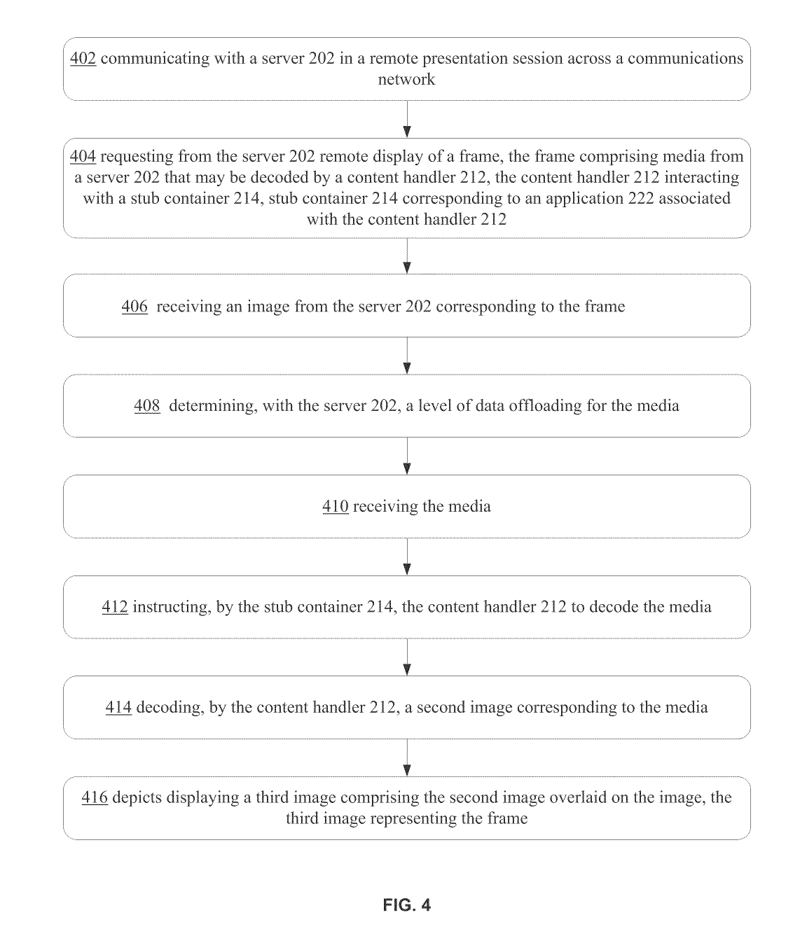

FIG. 4 illustrates example operational procedures for a client 204 engaged in a remote presentation session in which there is offloading of content retrieval and decoding in a pluggable content-handling system.

Operation 402 depicts communicating with a server 202 in a remote presentation session across a communications network.

Operation 404 depicts requesting from the server 202 remote display of a frame, the frame comprising media from a server 202 that may be decoded by a content handler 212, the content handler 212 interacting with a stub container 214, stub container 214 corresponding to an application 222 associated with the content handler 212.

Operation 406 depicts receiving an image from the server 202 corresponding to the frame.

Operation 408 depicts determining, with the server 202, a level of data offloading for the media. In an embodiment, a level of data offloading comprises: offloading access of the media, and offloading presentation of the media.

Operation 410 depicts receiving the media. In an embodiment, receiving the media comprises receiving the media from a second server 208, the media received from the second server 202 without having been transmitted by the server 202. In an embodiment, this includes receiving from the server 202 an indication of how to receive media from the second server 208.

In an embodiment, receiving the media comprises receiving the media from the server 202, the server 202 having received the media from a second server 208. In an embodiment where the present operational procedures are performed by a client 204, the server 202 is configured to receive the media from the second server 208, but the client 204 is not configured to receive the media from the second server 208.

Operation 412 depicts instructing, by the stub container 214, the content handler 212 to decode the media.

Operation 414 depicts decoding, by the content handler 212, a second image corresponding to the media.

Operation 416 depicts displaying a third image comprising the second image overlaid on the image, the third image representing the frame. The third image may be the constructed frame, such as a SILVERLIGHT™ video overlaid on top of its enclosing web browser window.

In an embodiment, a client performing the operations of FIG. 4 may effectuate this by creating a parent window for the remote presentation session on the client display (such as in a frame buffer in memory, where these frames are then flushed to the display screen to produce graphical output). The client may display received frames from the server (e.g. a web browser window), and delegate a child window within the parent window (a portion of the parent window) to the content handler, which then performs rendering operations for the second image (e.g. a video embedded in the web page). So, while the client renders the image to the parent window as the image is refreshed, the content handler may render the second image to the child window. In this way, the frame rates of the image and the second image are independent of each other. In this embodiment, the resulting third image is the full parent window, inclusive of the child window contained within.

It may be that a portion of the video image is to be obscured, such as if its partially covered by another web browser window. In an embodiment, operation 416 comprises receiving an indication that a portion of the second image is obscured by the image; and displaying a third image comprising the second image overlaid on the image further comprises: displaying only the portion of the second image unobscured by the image overlaid on the image.

In an embodiment, this comprises receiving an indication of a location to display the second image, wherein displaying the second image comprises displaying the second image at the location.

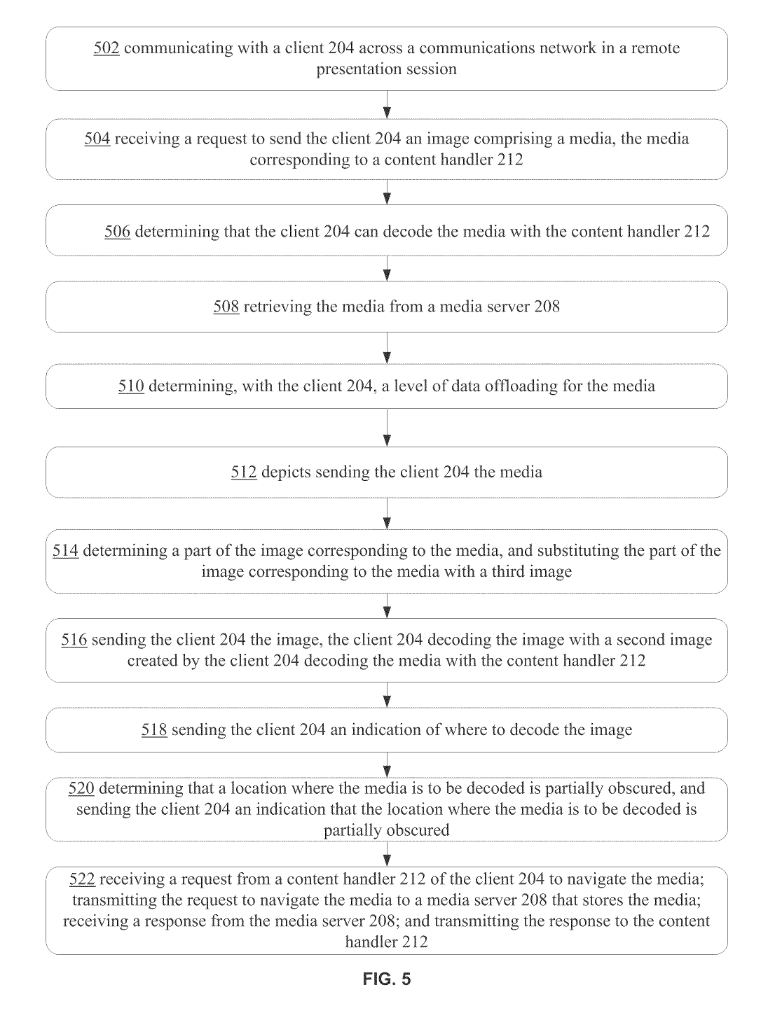

FIG. 5 illustrates example operational procedures for a server 202 engaged in a remote presentation session in which there is offloading of content retrieval and decoding in a pluggable content-handling system.

Operation 502 depicts communicating with a client 204 across a communications network in a remote presentation session.

Operation 504 depicts receiving a request to send the client 204 an image comprising a media, the media corresponding to a content handler 212. In an embodiment, the image is a frame of an application output. For instance, the image may be a web browser window that comprises an embedded video (the media) that is to be displayed within the browser window.

Operation 506 depicts determining that the client 204 can decode the media with the content handler 212.

Operation 508 depicts retrieving the media from a media server 208.

Operation 510 depicts determining, with the client 204, a level of data offloading for the media. In an embodiment, the level of data offloading corresponds to retrieval of the media or decoding of the media.

Operation 512 depicts sending the client 204 the media. In an embodiment, this comprises sending the client 204 an indication of a location of the media on a media server 208.

Operation 514 depicts determining a part of the image corresponding to the media, and substituting the part of the image corresponding to the media with a third image. For instance, where the image comprises a web browser window to be sent as a frame to client 204, there will be a “hole” in the image where the media normally would be, but is missing, because the media will be separately sent to client 202.

Operation 516 depicts sending the client 204 the image, the client 204 overlaying the image with a second image, the second image created by the client 204 decoding the media with the content handler 212.

Operation 518 depicts sending the client 204 an indication of where to decode the image.

Operation 520 depicts determining that a location where the media is to be decoded is partially obscured, and sending the client 204 an indication that the location where the media is to be decoded is partially obscured.

Operation 522 depicts receiving a request from a content handler 212 of the client 204 to navigate the media; transmitting the request to navigate the media to a media server 208 that stores the media; receiving a response from the media server 208; and transmitting the response to the content handler 212.

FIG. 6A depicts a first browser window 602 in which media is displayed 604, and a second browser window 606, as referenced in FIG. 2.

FIG. 6B depicts the first browser window 602 and second browser window 606 of FIG. 6A in which the second browser window 606 obscures a portion of the media 604 displayed in the first browser window 602.

### CONCLUSION

While the present disclosure has been described in connection with the preferred aspects, as illustrated in the various figures, it is understood that other similar aspects may be used or modifications and additions may be made to the described aspects for performing the same function of the present disclosure without deviating therefrom. Therefore, the present disclosure should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method, comprising:
communicating with a server in a remote presentation session across a communications network, wherein the server sends a frame for display, the frame comprising media from a server that may be decoded by a content handler, the content handler interacting with a stub container, the stub container corresponding to an application associated with the content handler;
receiving the media;
instructing, by the stub container, the content handler to decode the media;
decoding, by the content handler, an image corresponding to the media; and
displaying the image.

2. The method of claim 1, further comprising:
receiving a second image from the server; and displaying the image comprises:
displaying a third image comprising the second image overlaid on the image, the third image representing the frame.

3. The method of claim 1, wherein the server comprises a proxy content handler and a second application, the proxy content handler corresponding to a content handler of the server, the proxy content handler corresponding to the content handler, the second application corresponding to the application.

4. The method of claim 1, wherein receiving the media comprises:
receiving the media from a second server, the media received from the second server without having been transmitted by the server.

5. The method of claim 4, further comprising:
receiving from the server an indication of how to receive media from the second server.

6. The method of claim 1, wherein receiving the media comprises:
receiving the media from the server, the server having received the media from a second server.

7. The method of claim 6, the method being performed by a client, wherein the server is configured to receive the media from the second server, but the client is not configured to receive the media from the second server.

8. The method of claim 1, further comprising:
determining, with the server, a level of data offloading for the media, the level of data offloading comprises offloading access of the media, or offloading presentation of the media.

9. The method of claim 1, further comprising:
receiving an indication that a portion of the second image is obscured by the image; and
displaying a third image comprising the second image overlaid on the image further comprises: displaying only the portion of the second image unobscured by the image overlaid on the image.

10. The method of claim 1, further comprising:
receiving an indication of a location to display the second image; and
wherein displaying the second image comprises displaying the second image at the location.

11. A system, comprising:
circuitry for communicating with a client across a communications network in a remote presentation session;
circuitry for determining to send the client an image comprising a media and a subimage;
circuitry for determining that the client can decode the media with the content handler;
circuitry for sending the client the media; and
circuitry for sending the client the subimage, the client displaying a representation of the image comprising the subimage overlaid with a second image, the second image created by the client decoding the media.

12. The system of claim 11, further comprising:
circuitry for receiving a communication from the client, the communication directed to a media server that stores the media;
circuitry for transmitting the communication to a media server that stores the media;
circuitry for receiving a response from the media server; and
circuitry for transmitting the response to the client.

13. The system of claim 11. wherein the communication comprises an indication to navigate the media.

14. The system of claim 11, further comprising:
circuitry for determining a part of the subimage corresponding to the media; and
circuitry for substituting the part of the subimage corresponding to the media with a third image.

15. The system of claim 11, further comprising:
circuitry for sending the client an indication of where to overlay the second image.

16. The system of claim 11, wherein the circuitry for sending the client the media comprises:
circuitry for sending the client an indication of a location of the media on a media server.

17. The system of claim 11, further comprising:
circuitry for retrieving the media from a media server.

18. The system of claim 11, further comprising:
circuitry for determining, with the client, a level of data offloading for the media.

19. The system of claim 11, further comprising:
circuitry for determining that a location where the media is to be decoded is partially obscured; and
sending the client an indication that the location where the media is to be decoded is partially obscured.

20. A computer-readable storage medium, comprising computer-executable instructions that, when executed on a computing device, cause the computing device to:
communicate with a server in a remote presentation session across a communications network;
receive from the server an indication to display a frame, the frame comprising an image and media from a server that may be decoded by the content handler;
receive the image from the server;
receive the media;
decode, by the content handler, a second image corresponding to the media; and
display the second image overlaid on the image.
